(19) United States
(12) Patent Application Publication
(10) Pub. No.: US 2013/0270987 A1
(43) Pub. Date: Oct. 17, 2013

(54) FREEZER SLIDE RACK ALIGNMENT

(71) Applicant: Paul H. Kelly, Anderson, SC (US)

(72) Inventor: Paul H. Kelly, Anderson, SC (US)

(73) Assignee: ELECTROLUX HOME PRODUCTS, INC., Charlotte, NC (US)

(21) Appl. No.: 13/448,619

(22) Filed: Apr. 17, 2012

(51) Int. Cl. A47B 88/12; B23Q 3/00

(52) U.S. Cl. 312/331; 29/464

(57) ABSTRACT

A drawer assembly for an enclosure includes a first rack, a second rack and a drawer. Each of the racks includes a first set of teeth provided longitudinally along thereof. A drawer is configured to be movable in and out of the enclosure and includes a first pinion and a second pinion rotatably coupled near a first face and a second face respectively. The pinions include a second set of teeth provided circumferentially. The first pinion and the second pinion are configured to rotate along the first rack and the second rack respectively through engagement of the second set of teeth with the first set of teeth. Each of the first rack and the second rack includes an alignment area provided at a front portion and a rear portion thereof, and the alignment area includes a third set of teeth shorter in height than the second set of teeth.

### TECHNICAL FIELD

The present disclosure relates to cabinet drawers and, more particularly, drawers that open and close through a rack-and-pinion mechanism.

### BACKGROUND

Certain cabinets are built with drawers that are opened and closed by way of a rack-and-pinion mechanism. Specifically, the pinion rotates along the rack as the drawer moves in and out of the cabinet. Both of the pinion and the rack have a set of teeth which mesh one another to help the drawer to be opened and closed in a controlled and straight manner. However, these types of drawers are susceptible to becoming misaligned if one side of the drawer is pulled abruptly and the engagement of the teeth along a lateral edge of the drawer becomes misaligned with the engagement of the teeth along the other lateral edge of the drawer. Such misalignment prevents the drawer from shutting properly and disrupts the operation of the cabinets, such as refrigerators, by causing incorrect readings of various surrounding conditions. Thus, there is a need for a means to correct the misalignment of the drawer using a rack-and-pinion mechanism.

### SUMMARY

In one example aspect, a drawer assembly for an enclosure includes a first interior surface and a second interior surface, and the interior surfaces are opposite one another. The drawer assembly includes a first rack and a second rack and a drawer. The first rack and the second rack are mounted respectively near the first interior surface and the second interior surface. Each of the racks includes a first set of teeth provided longitudinally along thereof. The drawer is configured to be movable in and out of the enclosure and includes a first face near the first interior surface and a second face near the second interior surface. The drawer includes a first pinion and a second pinion rotatably coupled near the first face and the second face respectively. The pinions include a second set of teeth provided circumferentially. The first pinion and the second pinion are configured to rotate along the first rack and the second rack respectively through engagement of the second set of teeth with the first set of teeth. Each of the first rack and the second rack includes an alignment area provided at a front portion and a rear portion thereof, and the alignment area includes a third set of teeth shorter in height than the second set of teeth.

In one example of the one example aspect, the third set of teeth is of a height such that the first pinion and the second pinion can rotate along the first rack and the second rack respectively through engagement of the second set of teeth with the third set of teeth in the alignment area, and such that the first pinion and the second pinion can move relative to the first rack and to the second rack respectively in the alignment area without the second set of teeth being fully meshed with the third set of teeth.

In another example of the one example aspect, a misalignment of the drawer can be corrected as each of the first pinion and the second pinion moves over the alignment area of the first rack and the second rack respectively.

In yet another example of the one example aspect, a timing bar is configured to couple the first pinion and the second pinion so that the pinions rotate as one, and the timing bar becomes perpendicular to the first rack and the second rack through correction of the misalignment of the drawer.

In yet another example of the one example aspect, the first set of teeth and the second set of teeth are substantially similar in height.

In yet another example of the one example aspect, the third set of teeth is about 30 percent of a height of the second set of teeth.

In another example aspect, a method of aligning a drawer of a drawer assembly is provided. The drawer assembly is provided for an enclosure including a first interior surface and a second interior surface, and the interior surfaces are opposite one another. The drawer assembly includes a first rack, a second rack and the drawer. The first rack and the second rack are mounted respectively near the first interior surface and the second interior surface. Each of the racks includes a first set of teeth provided longitudinally thereof. The drawer is configured to be movable in and out of the enclosure and includes a first face near the first interior surface and a second face near the second interior surface. The drawer includes a first pinion and a second pinion rotatably coupled near the first face and the second face respectively. The pinions include a second set of teeth provided circumferentially. The first pinion and the second pinion are configured to rotate along the first rack and the second rack respectively through engagement of the second set of teeth with the first set of teeth. The method includes the step of providing an alignment area at a front portion and a rear portion of the first rack and the second rack. The alignment area includes a third set of teeth shorter in height than the second set of teeth.

In one example of the another example aspect, the method further includes the step of aligning the drawer such that the first face and the second face are parallel to the first interior surface and the second interior surface respectively by maneuvering the drawer to either a fully open position or closed position such that each of the first pinion and the second pinion enters the alignment area.

In another example of the another example aspect, the third set of teeth is of a height such that the first pinion and the second pinion can rotate along the first rack and the second rack respectively through engagement of the second set of teeth with the third set of teeth in the alignment area, and such that the first pinion and the second pinion can move over the first rack and the second rack respectively in the alignment area without the second set of teeth being fully meshed with the third set of teeth.

### BRIEF DESCRIPTION OF THE DRAWINGS

These and other aspects are better understood when the following detailed description is read with reference to the accompanying drawings, in which:

FIG. 1 is an exploded perspective view of an example embodiment of a drawer assembly for a cabinet;

FIG. 2 is an assembled side view of a motion control mechanism of the drawer assembly;

FIG. 3 is a close-up view of an interface between a pinion and a rack at an alignment area;

FIG. 4 is an isolated side view of the rack; and

FIG. 5 is a close-up view of a first set of teeth and a third set of teeth on the rack.

### DETAILED DESCRIPTION

Examples will now be described more fully hereinafter with reference to the accompanying drawings in which example embodiments are shown. Whenever possible, the same reference numerals are used throughout the drawings to refer to the same or like parts. However, aspects may be embodied in many different forms and should not be construed as limited to the embodiments set forth herein.

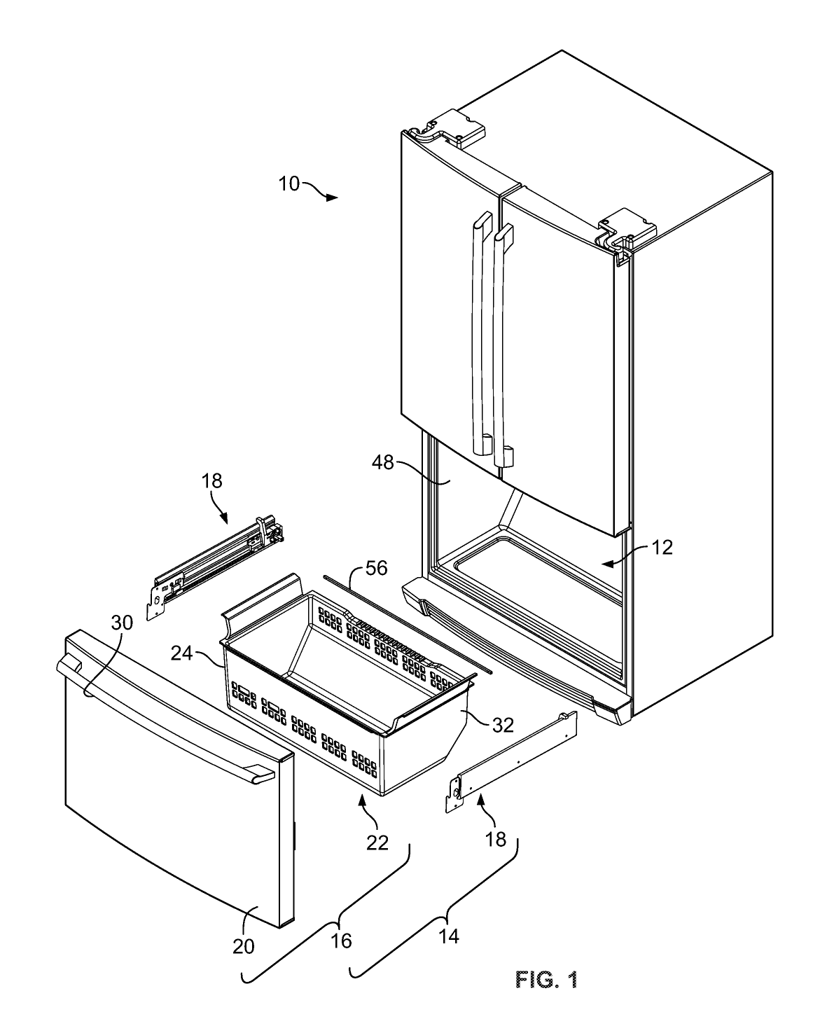

Referring now to FIG. 1, a cabinet for implementing the apparatus described herein is shown. The cabinet 10 shown in FIG. 1 is an appliance and, more specifically, a refrigerator with a fresh-food compartment with French doors and a bottom-mounted freezer compartment although other embodiments can include refrigerators with an alternative arrangement of compartments. The cabinet 10 can also be any other cabinet-like structure that provides a storage space or an enclosure 12 and may be characterized as a drawer, a desk, a container, a chest, a safe, a cupboard, a cabinet or the like. The storage space of the cabinet 10 may be provide a particular type of environment for items stored therein and, for example, may be suitable for refrigeration, heating, sanitization, a vacuum, etc.

One of the enclosures 12 may accommodate a drawer assembly 14 which a box-like configuration and is insertable in the enclosure 12. The enclosure 12 may be shaped to accommodate such a drawer assembly 14. The drawer 16 may have a shape other than that of a box and, for example, may be semi-cylindrical. As shown in FIG. 1, the enclosure 12 of the cabinet 10 may be provided such that a drawer 16 makes up the entire compartment and is accessed directly from the exterior of the cabinet 10 by opening a door of the compartment. Alternatively, the drawer 16 may make up a part of a compartment and may need to be pulled out after a door of such a compartment is first opened.

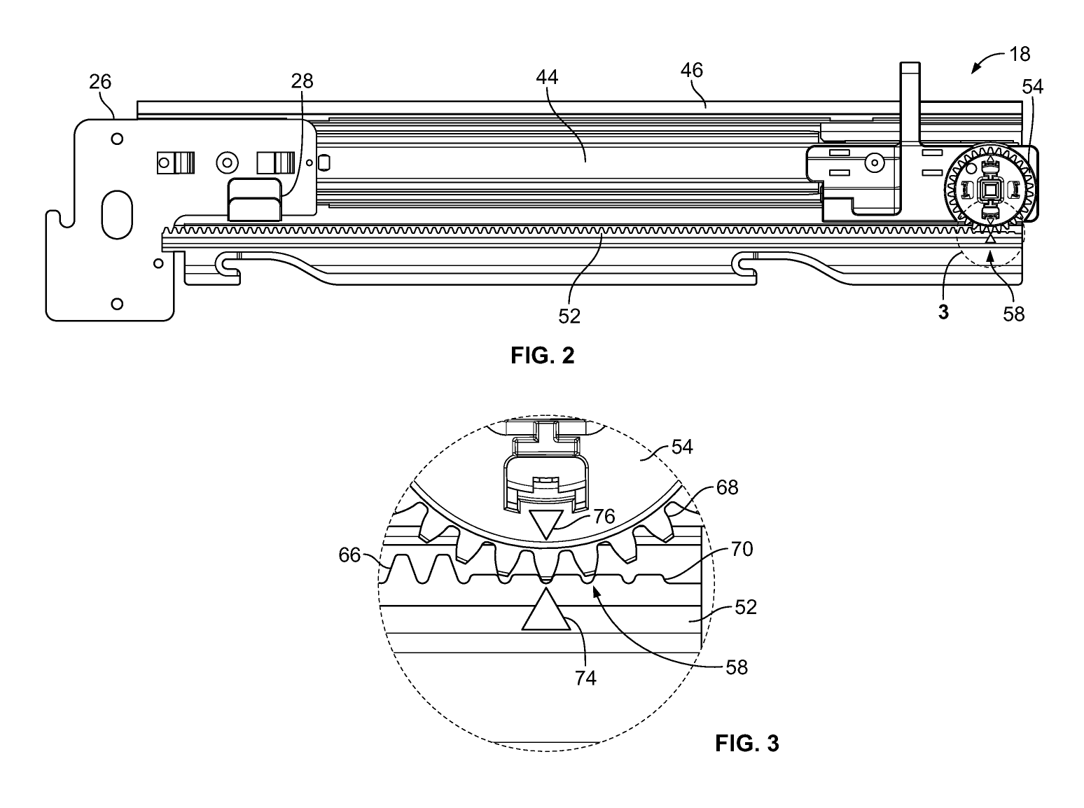

FIG. 1 shows an exploded view of an example embodiment of the drawer assembly 14. In the present embodiment, the drawer assembly 14 includes a drawer 16 and a pair of motion control mechanisms 18. The drawer 16 may include a door portion 20 and a basket portion 22. Moreover, the basket portion 22 may include a basket 24 and side supports 26 (FIG. 2).

As shown in FIG. 1, the door portion 20 of the drawer 16 may be configured to conform in shape to other parts of the cabinet 10 and may include a grasping means, such as a handle 30, so that the drawer 16 can be manually pulled out of and pushed into the enclosure 12. The basket 24 of the basket portion 22 may be flanked on substantially opposite locations by the side supports 26. The side supports 26 may be plate-like components allowing the basket 24 to be secured therebetween using a variety of means known in the art, such as snap-ins, screws, nuts and bolts, hooks, glue, etc. In the present embodiment, the side supports 26 include a plurality of pedestals 28 (FIG. 2) for receiving wire portions of the basket 24. While the basket 24 may be formed from multiple parts such as interwoven wires, the basket 24 may also be formed by molding polymeric material as in the present embodiment. The basket 24 may be box-shaped so as to have multiple outer faces 32.

As shown in FIG. 2, each motion control mechanism 18 may include a linear motion element 44 in order to allow the drawer 16 to move in and out of the enclosure 12 and a rack-and-pinion structure in order to prevent tilting of the drawer 16 during linear movement. In the present embodiment, the motion control mechanism 18 includes a mounting bracket 46 (FIG. 1) about which the linear motion element 44 and the rack-and-pinion structure may be mounted. The mounting brackets 46 may be mounted on or near two interior surfaces which are disposed opposite one another in the enclosure 12. The motion control mechanisms 18 allow the drawer 16 to move between an extended, open state and a retracted, closed state. As shown in FIG. 2, the motion control mechanism 18 may include the mounting bracket 46, the linear motion element 44, a rack 52 and a pinion 54. A timing bar 56 connects the motion control mechanisms 18 to help the linear motion elements 44 advance substantially equally on each side of the drawer 16 (FIG. 1).

The linear motion element 44 may, for example, be a slide mechanism that may utilize a plurality of elongate members that slide or glide against one another. Linear motion may also be enabled using telescopic members that have varying cross-sections and are housed within one another in a retracted position. The cross-sectional shapes may vary and, for example, have a “U” shape, a circular shape, etc. The linear motion may be enabled using plain bearings, such as dovetail slides, ball bearings, roller bearings, or other means known in the art. The linear motion element 44 may utilize alternative structures such as wheels rolling about rails. The elongate members may include a stationary member and a moving member that moves relative to the stationary member to move between the retracted position and the extended position. Alternatively, the elongate members may include one or more intermediate members linking the stationary member to the moving member but the stationary member and the moving member may still correspond to the outermost portions of the linear motion element 44 in the extended position.

As shown in FIGS. 2-3, the rack 52 may be provided on the mounting bracket 46 so as to be adjacent the linear motion elements 44 and the pinion 54 such that, as the drawer 16 moves in and out of the enclosure 12, the pinion 54 is allowed to rotate along the rack 52. The rack 52 is arranged to be parallel with the directions of the movement of the drawer 16 in and out of the enclosure 12. The rack 52 is provided longitudinally with a set of first teeth 66 which are adapted to mesh with a set of second teeth 68 that are circumferentially provided on the pinion 54. The second teeth 68 may be substantially similar in height to the first teeth 66. The first teeth 66 are provided longitudinally along a top edge of the rack 52. The pinions 54 near each interior surface 48 of the enclosure 12 are coupled to one another through the timing bar 56 in order to ensure that the pinions 54 rotate as one undergoing the same angular rotation at all times. The timing bar 56 is configured to be perpendicular to the directions of movement of the drawer 16 and to the racks 52.

In order to ensure that the pinion 54 is mounted at identical locations on each rack 52 on both sides of the drawer 16, the rack 52 may be provided with a first marking 74 and the pinion 54 may be provided with a second marking 76 as shown in FIG. 3. The first marking 74 may indicate a predetermined location along the length of the rack 52 at which the pinion 54 should engage the rack 52 when these two components are assembled together and the second marking 76 may indicate a predetermined angular position of the pinion 54 for such an assembly. The markings 74, 76 may be configured on portions of the pinion 54 and the rack 52 that are visible to allow an assembly line worker to properly align the parts and, for example, may be provided on a side surface of the pinion 54 and a side surface of the rack 52 as shown in FIG. 3. The markings 74, 76 can be embodied through engraving, printing, or other means known in the art and may have shapes that can indicate a state of alignment such as an arrow, a triangle, a line or the like.

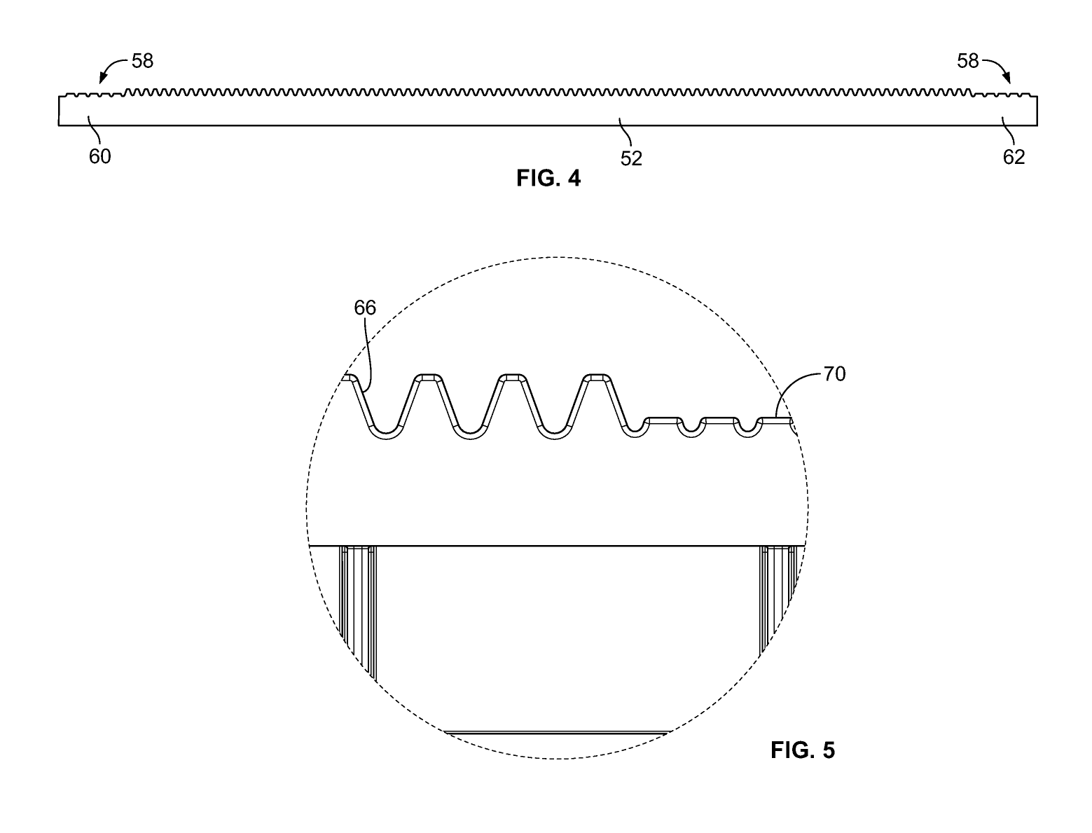

As shown in FIG. 4, each rack 52 may include an alignment area 58 which is provided at a front portion 60 and a rear portion 62 of each rack 52. The alignment area 58 includes third teeth 70 that may be shorter than the second teeth 68 and/or the first teeth 66. For example, the third teeth 70 may be about 30 percent the height of the second teeth 68 but the height of the third teeth 70 relative to the second teeth 68 may vary and be smaller or larger than 30 percent.

The shorter height of the third teeth 70 allows the second teeth 68 of the pinion 54 to become fully or partially disengaged from the third teeth 70 thereby allowing the second teeth 68 jump certain third teeth 70 without the second teeth 68 being fully meshed with the third teeth 70. Thus, the first pinion 54 and the second pinion 54 can move relative to the first rack 52 and the second rack 52 without undergoing rotation or while undergoing only partial rotation. This ability of the second teeth 68 to jump certain third teeth 70 helps correct possible tilting of the timing bar 56 that may arise from sudden pulling of the drawer 16. Unless the tilting of the timing bar 56 is corrected, the drawer 16 generally continues to move in and out of the enclosure 12 in a tilted state. The alignment areas 58 allow the tilting of the timing bar 56 and the misalignment of the drawer 16 to be corrected either when the drawer is fully opened (and the pinion 54 passes over the alignment area 58 at the front portion 60) or when the drawer is fully closed (and the pinion 54 passes over the alignment area 58 at the rear portion 62).

The drawer assembly 14 may include a self-closing mechanism (not shown) which enables the drawer 16 to reach a fully closed position when the drawer 16 nears the fully closed position. The self-closing mechanism may be embodied as a spring-biased closing mechanism and the force of the self-closing mechanism acting on the drawer 16 may cause the drawer 16 to correct its tilting without any intervention by a user of the drawer 16.

It will be apparent to those skilled in the art that various modifications and variations can be made without departing from the spirit and scope of the claimed invention.

What is claimed is:

1. A drawer assembly for an enclosure including a first interior surface and a second interior surface, the interior surfaces being opposite one another, the drawer assembly including:
a first rack and a second rack mounted respectively near the first interior surface and the second interior surface, each of the racks including a first set of teeth provided longitudinally along thereof; and
a drawer configured to be movable in and out of the enclosure and including a first face near the first interior surface and a second face near the second interior surface, the drawer including a first pinion and a second pinion rotatably coupled near the first face and the second face respectively, the pinions including a second set of teeth provided circumferentially, the first pinion and the second pinion configured to rotate along the first rack and the second rack respectively through engagement of the second set of teeth with the first set of teeth, wherein each of the first rack and the second rack includes an alignment area provided at a front portion and a rear portion thereof, and the alignment area includes a third set of teeth shorter in height than the second set of teeth.

2. The drawer assembly of claim 1, wherein the third set of teeth is of a height such that the first pinion and the second pinion can rotate along the first rack and the second rack respectively through engagement of the second set of teeth with the third set of teeth in the alignment area, and such that the first pinion and the second pinion can move relative to the first rack and to the second rack respectively in the alignment area without the second set of teeth being fully meshed with the third set of teeth.

3. The drawer assembly of claim 2, wherein a misalignment of the drawer can be corrected as each of the first pinion and the second pinion moves over the alignment area of the first rack and the second rack respectively.

4. The drawer assembly of claim 3, wherein a timing bar is configured to couple the first pinion and the second pinion so that the pinions rotate as one, and the timing bar becomes perpendicular to the first rack and the second rack through correction of the misalignment of the drawer.

5. The drawer assembly of claim 1, wherein the first set of teeth and the second set of teeth are substantially similar in height.

6. The drawer assembly of claim 1, wherein the third set of teeth is about 30 percent of a height of the second set of teeth.

7. A method of aligning a drawer of a drawer assembly, the drawer assembly provided for an enclosure including a first interior surface and a second interior surface, the interior surfaces being opposite one another, the drawer assembly including a first rack, a second rack and the drawer, the first rack and the second rack mounted respectively near the first interior surface and the second interior surface, each of the racks including a first set of teeth provided longitudinally thereof, the drawer configured to be movable in and out of the enclosure and including a first face near the first interior surface and a second face near the second interior surface, the drawer including a first pinion and a second pinion rotatably coupled near the first face and the second face respectively, the pinions including a second set of teeth provided circumferentially, the first pinion and the second pinion configured to rotate along the first rack and the second rack respectively through engagement of the second set of teeth with the first set of teeth, the method including the step of:
providing an alignment area at a front portion and a rear portion of the first rack and the second rack, the alignment area including a third set of teeth shorter in height than the second set of teeth.

8. The method of claim 7, further including the step of:
aligning the drawer such that the first face and the second face are parallel to the first interior surface and the second interior surface respectively by maneuvering the drawer to either a fully open position or closed position such that each of the first pinion and the second pinion enters the alignment area.

9. The method of claim 7, wherein the third set of teeth is of a height such that the first pinion and the second pinion can rotate along the first rack and the second rack respectively through engagement of the second set of teeth with the third set of teeth in the alignment area, and such that the first pinion and the second pinion can move over the first rack and the second rack respectively in the alignment area without the second set of teeth being fully meshed with the third set of teeth.
